(19) United States
(12) Patent Application Publication
(10) Pub. No.: US 2025/0365843 A1
(43) Pub. Date: Nov. 27, 2025

(54) METHOD AND A SYSTEM FOR GENERATING STABLE ULTRASHORT PULSES OF XUV AND SOFT X-RAY RADIATION

(71) Applicant: INSTITUT NATIONAL DE LA RECHERCHE SCIENTIFIQUE, Quebec (CA)

(72) Inventors: Romain MARCELINO, Montreal (CA); Ramin GHAHRI, Montreal (CA); Mangaljit SINGH, Saskatoon (CA); Tsuneyuki OZAKI, Brossard (CA)

(21) Appl. No.: 19/206,571

(22) Filed: May 13, 2025

Related U.S. Application Data
(60) Provisional application No. 63/650,687, filed on May 22, 2024.

(51) Int. Cl. H05G 2/00

(52) U.S. Cl. CPC H05G 2/0084; H05G 2/0086

(57) ABSTRACT

A system and a method for generating stable ultrashort pulses of XUV and soft X-ray radiation from laser-ablated plumes of a liquid target, using a laser source a pre-pulse and a laser source of a main pulse, by selecting the pre-pulse and the main pulse; directing and focusing the pre-pulse to a surface of the liquid target to ablate the surface of the liquid target, forming a plasma plume generating harmonics; the main pulse being selected for driving the harmonics.

### CROSS REFERENCE TO RELATED APPLICATIONS

This application claims benefit of U.S. provisional application Ser. No. 63/650,687, filed on May 22, 2024. All documents above are incorporated herein in their entirety by reference.

### FIELD OF THE INVENTION

The present invention is concerned with stable ultrashort pulses of XUV and soft X-ray radiation. More precisely, the present invention relates to a method and a system for generating stable ultrashort pulses of XUV and soft X-ray radiation.

### BACKGROUND OF THE INVENTION

Methods in laboratory to generate extreme ultraviolet radiation (XUV) include plasma emission and high-order harmonic generation (HHG) for example. High-order harmonic generation (HHG) is a highly nonlinear optical effect allowing achieving significantly high-frequency multiple orders of an intense laser beam, such as the 195th harmonic of a 1.51 μm laser, using interaction of a high-intensity ultrashort driving laser pulse with a nonlinear medium, as generally explained in the three-step model. In the three-step model, the first step is the tunnel ionization of a valence shell electron of an atom or ion, which, in a second step, is accelerated under the influence of the incident driving laser field, and in a last step, the electron recombines to the initial ground state and emits high-order harmonics. This method generates highly spatially and temporally coherent attosecond pulses in the extreme-ultraviolet and soft X-ray regions, unlike the plasma emission method, which emits incoherently. Nonlinear media used for high-order harmonic generation (HHG) include solids, liquids, gases, clusters and laser-ablated plumes (LAPs).

Since high-order harmonic generation (HHG) produces spatially and temporally coherent extreme ultraviolet (XUV) rays pulses, it has numerous valuable applications, such as biomedical imaging or in studying the dynamics of electrons in atoms and molecules. For example, the mouse hippocampal neurons were imaged using the 27th harmonic of a 780 nm pulse (29 nm wavelength). Such extreme ultraviolet (XUV) rays pulses are less destructive than X-rays from a synchrotron; moreover, they have a better resolution than fluorescence. It was also possible to visualize the highest occupied molecular orbitals (HOMO) of N₂ using high-harmonic spectroscopy.

The method of high-order harmonic generation (HHG) from laser-ablated plumes (LAPs) is similar to high-order harmonic generation (HHG) from gases, the difference being the use of an ablation plume, created by focusing a pre-pulse laser beam onto a solid target, instead of gas, as the nonlinear media for high-order harmonic generation (HHG), and the phenomenon of resonant harmonic (RH), which involves the intensity enhancement of a harmonic by more than two orders of magnitude as compared to the neighboring harmonics, occurring in high-order harmonic generation (HHG) from LAP. The singly charged gallium ion (Ga+) exhibits a resonance near 56.6 nm. When driven by a 400 nm laser, the 7th harmonic of gallium becomes resonant, with an enhancement factor of 714, resulting in a high-order harmonic source with unparalleled monochromaticity and intensity.

However, generating high-order harmonic generation (HHG) from laser-ablated plumes (LAPs) presents challenges. A major lingering issue since its first demonstration is the limited number of shots for stable high-order harmonic generation (HHG) from laser-ablated plumes (LAPs) when shooting at the same position on the target. If the solid target is not moved, the surface will form a crater after multiple laser shots. The deformation of the target surface due to the crater will alter the plasma conditions of the LAP, thereby reducing XUV emission via HHG. For example, HHG from the LAP of solid Indium lasts for 2,500 shots (less than a minute for a 50 Hz laser), after which the XUV flux starts to decrease drastically (FIG. 1). To maintain the high XUV flux of HHG from LAP, the solid target is typically moved after a certain number of shots so that the pre-pulse interacts with a fresh target surface. However, since the area of the solid target is finite, it needs to be replaced with a new one after a specific time, which requires breaking the vacuum and opening the chamber. Such replacements also involve realignment of the system, which could change the various characteristics of the XUV emission. Such changes could complicate the use of this XUV source in various applications that require stable and reproducible XUV pulses (MM-DTEM).

Further, incoherent XUV emission typically requires a strongly ionized plasma. For this purpose, an intense laser is focused on the target, and it creates a hot LAP. However, as discussed hereinabove in relation to HHG, surface degradation will significantly alter the plasma conditions of the LAP, thereby reducing the XUV flux after multiple shots at the same position on the target. In conclusion, the generation of incoherent and coherent XUV radiation currently experiences a severe stability issue if the target surface is not refreshed after each laser shot.

To solve the rapid decrease in the XUV flux, liquid-jet tin targets have been used; the issue with using a liquid jet is that a pumping system is needed for continuous liquid flow. There is also the issue of clogging the jet nozzle when the liquid metal passes through, due to the drop in the temperature of the liquid metal. Further, the large debris produced by the liquid jet's ablation can damage the optical components in the vacuum chamber.

Another method was presented using a rotating cylindrical target to generate harmonics from LAP. This method of rotating targets also has a limited number of shots, although it is typically much larger than a planar target. As such, after some time, the vacuum of the system needs to be broken to change the rods with a new one and then realign, which is not ideal for various applications.

For incoherent XUV sources, metal droplets have been used as the target. For metal droplet targets, the repetition rate and the stability of the XUV emission are challenging. The repetition rate of the metal droplets needs to be synchronized in time and space with the laser pulses. Any instability in this timing will result in shot-to-shot variations in the XUV intensity, which would be a serious problem for the industry, such as in the fabrication of semiconductor microprocessors.

There has been significant interest in generating coherent XUV radiation with laser-like characteristics. RH from LAP has been a source that has gained considerable attention due to its high spatial coherence, ultrashort pulse nature and high intensity. However, RH from the LAP of the solid target can last only for 1000 shots due to the fast degradation of the surface and improving the stability of RH has been a challenge. Researchers who were interested in generating intense and stable XUV pulses turned to liquid jet systems, but since the generated XUV radiation is incoherent with few picosecond to nanosecond pulse durations, it could not be used for applications such as coherent diffraction imaging. Further, forming a liquid jet in a vacuum requires a complicated pump system, and the nozzle could easily be clogged with the target material.

There is still a need in the art for a method and a system for generating stable ultrashort pulses of XUV and soft X-ray radiation.

### SUMMARY OF THE INVENTION

More specifically, in accordance with the present invention, there is provided a system for generating stable ultrashort pulses of XUV and soft X-ray radiation from laser-ablated plumes of a liquid target, comprising a laser source a pre-pulse, a laser source of a main pulse, wherein the pre-pulse is directed and focused to a surface of the liquid target to ablate the surface of the liquid target, forming a plasma plume generating harmonics; the main pulse being selected for driving the harmonics.

There is further provided a method for generating stable ultrashort pulses of XUV and soft X-ray radiation from laser-ablated plumes of a liquid target, comprising selecting a pre-pulse and a main pulse; directing and focusing the pre-pulse to a surface of the liquid target to ablate the surface of the liquid target, forming a plasma plume generating harmonics; the main pulse being selected for driving the harmonics.

Other objects, advantages and features of the present invention will become more apparent upon reading the following non-restrictive description of specific embodiments thereof, given by way of example only with reference to the accompanying drawings.

### BRIEF DESCRIPTION OF DRAWINGS

In the appended drawings:

FIG. 1 shows the intensity variation of solid indium 13^{th} harmonic as a function of time and number of laser shots pumped with 793 nm driving laser wavelength;

FIG. 2A shows the normalized 13^{th} harmonic intensity from a LAP of solid indium and a LAP from liquid gallium as a function of time and number of laser shots, with a logarithmic scale on the horizontal axis, according to an embodiment of an aspect of the present disclosure;

FIG. 2B shows the normalized intensity of 7^{th} harmonic from liquid gallium as a function of the number of laser shots, according to an embodiment of an aspect of the present disclosure;

FIG. 3A is a schematical view of a system according to an embodiment of an aspect of the present disclosure;

FIG. 3B shows details of the system of FIG. 3A according to an embodiment of an aspect of the present disclosure;

FIG. 3C shows details of the system of FIG. 3A according to an embodiment of an aspect of the present disclosure;

FIG. 3D shows the target surface in solid (left hand side) and liquid phases (right hand side);

FIG. 3E is a schematical view of a system according to an embodiment of an aspect of the present disclosure;

FIG. 3F is a schematical view of a system according to an embodiment of an aspect of the present disclosure;

FIG. 4 is a schematical view of temperature control according to an embodiment of an aspect of the present disclosure;

FIG. 5 is a schematical view of repetition rate control with an optical chopper;

FIG. 6 is a visualisation of a crater formed on liquid gallium by ablation using the system of FIGS. 3, the right hand-side tone bar representing depth in millimeters, according to an embodiment of an aspect of the present disclosure;

FIG. 7A shows the crater on the gallium liquid a few seconds after ablation (J), the right hand-side tone bar representing depth in millimeters;

FIG. 7B shows the crater on the gallium liquid two days after the ablation (J+2), the right hand-side tone bar representing depth in millimeters;

FIG. 7C shows comparison of the depth of the crater a few seconds after the ablation (J) (dark shade) and two days after the ablation (J+2) (light shade), the right hand-side tone bar representing height in millimeters;

FIG. 8 shows variation of the surface position where the gallium is ablated versus time, each line corresponding to a linear fit of four series of experimental points;

FIG. 9 shows the surface position of gallium liquid versus time at four different ablation energies;

FIG. 10 shows a comparison of the variation of the gallium surface position versus time, between a solid gallium target and a liquid gallium target;

FIG. 11 shows the dynamic of the surface position versus time, each 10 μs, crosses representing the position of the surface after the impact with the ablation laser;

FIG. 12A shows the dynamic of the surface position after one laser shot;

FIG. 12B shows the surface position before and after the ablation, lines representing the linear fit of the respective curves; and

FIG. 13 is a dynamic visualization of the surface position for one pulse.

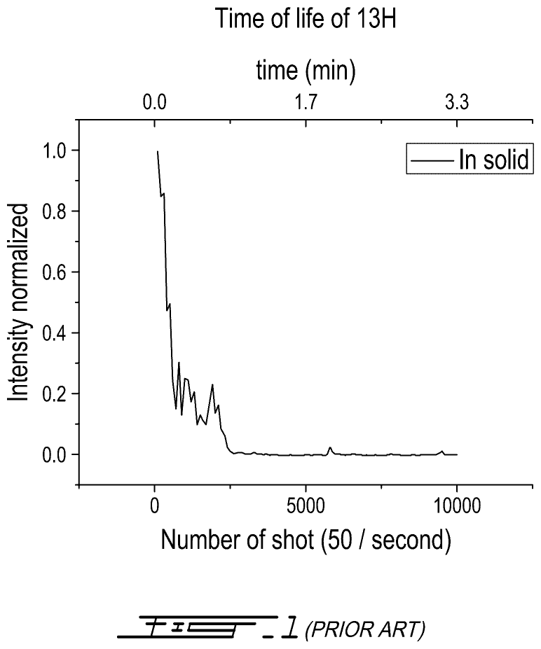

### DETAILED OF ILLUSTRATIVE EMBODIMENTS

The present invention is illustrated by the following non-limiting examples.

A method for generating coherent, femtosecond XUV, stable pulses using laser-ablated plumes (LAPs) using a target at a fixed position according to an embodiment of an aspect of the present disclosure is presented hereinafter.

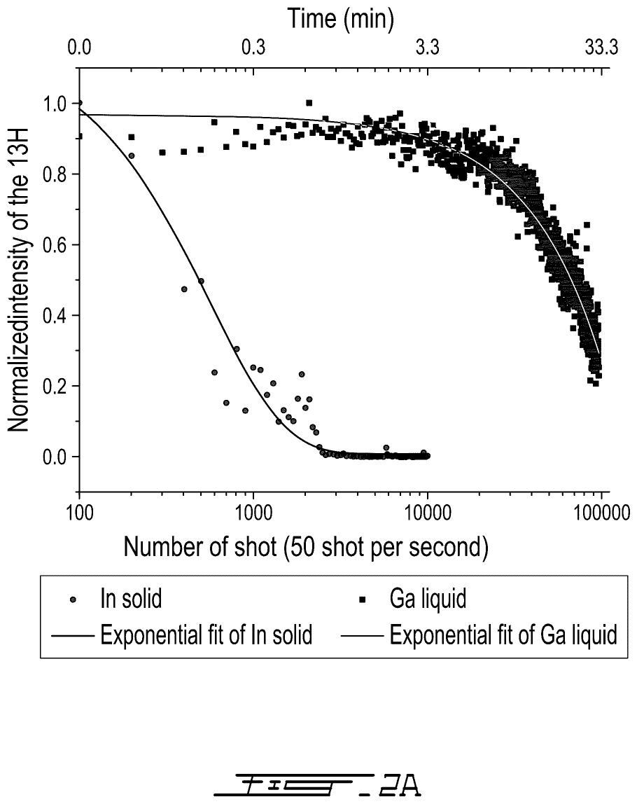

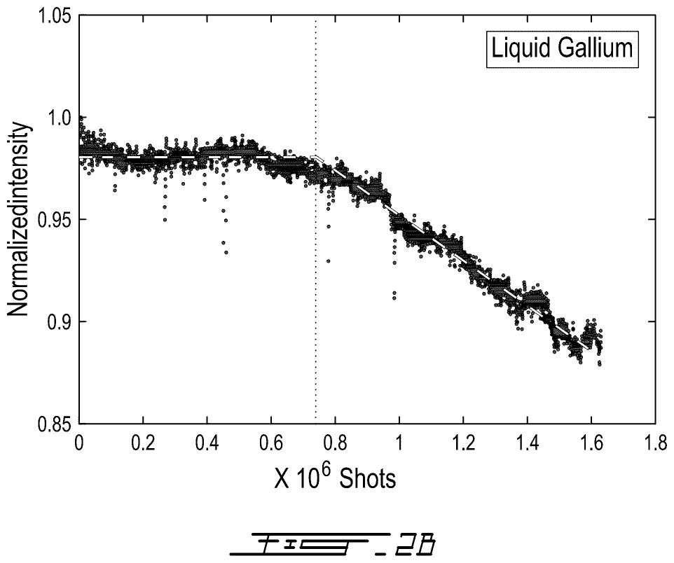

In experiments using liquid gallium to generate LAP, it is observed that the XUV pulses last for more than 72,000 shots (lasting more than 20 minutes at 50 Hz repetition rates, FIG. 2A), up to more than 800,000 shots (lasting more than 4 hours and 30 minutes at 50 Hz repetition rates (see FIG. 2B). The surface of the liquid gallium target remains stationary throughout the experiments, which allows the target to withstand 8 such a high number of shots at the same target position. In contrast, high-order harmonic generation (HHG) pulses from a solid gallium target last at most 1,000 shots (lasting 20 seconds at 50 Hz).

In other experiments, the same method is used to generate stable incoherent XUV radiation via LAP generated from a liquid metal target.

Thus, increasing the HHG stability by using a liquid metal target, the method allows uses of a femtosecond XUV source for up to more than 800,000 shots, whereas in the case of liquid X-ray sources, since typically a single shot displaces the liquid target, a continuously flowing source is necessary.

In the present disclosure, a pre-pulse of energy selected of at 0.5 mJ or more, for example in the range between about 0.5 and about 1 mJ, is used for ablation and generate harmonic from the plasma plume; a main pulse of energy selected in the range between about 1 and about 4 mJ is used for driving the harmonics; a probing pulse of a higher repetition rate than the repetition rate of the pre-pulse used for interferometry to probe the dynamics fast enough, i.e. for pre-pulse repetition rates of 50 Hz and 100 Hz (20 ms and 10 ms laser shot to shot respectively), a repetition rate of 100 kHz for example may be selected, with a light wavelength in the nanometer scale, for example of 1310 nm, allowing probing surface features, such as craters in the micrometer range (crater scale is in micrometer scale), as described hereinbelow.

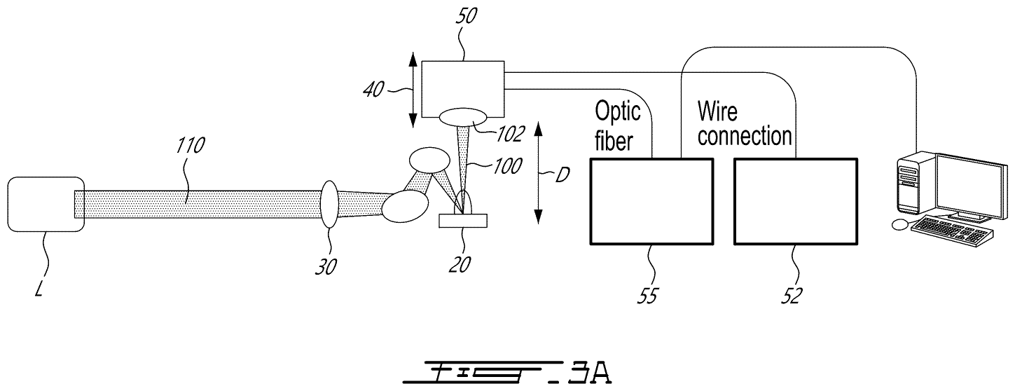

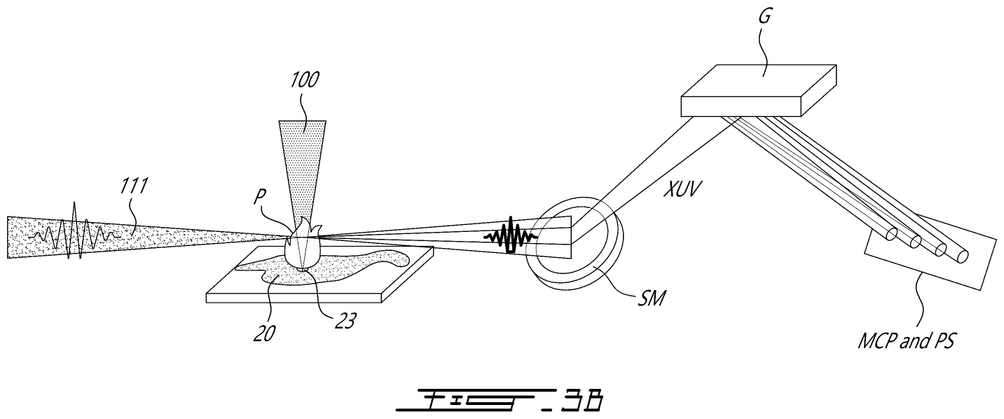

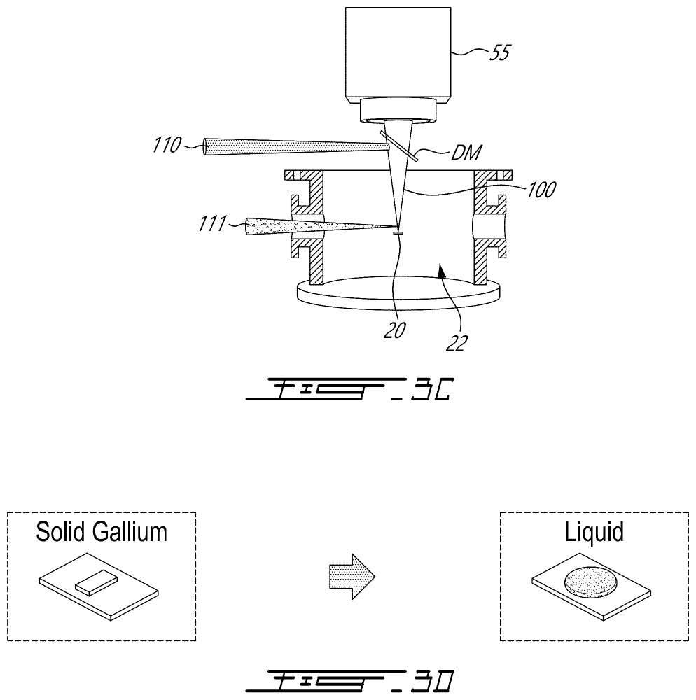

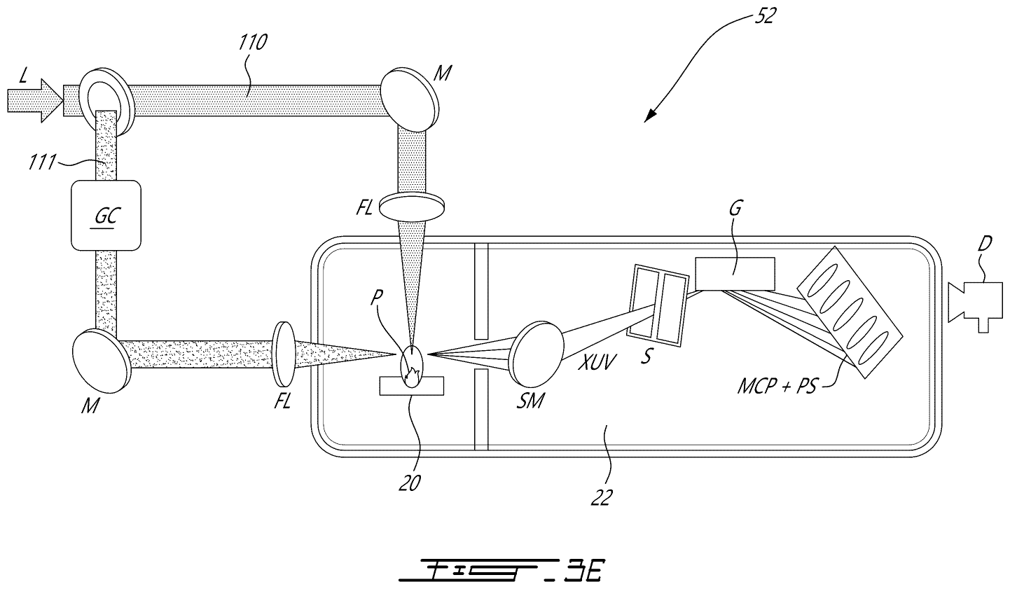

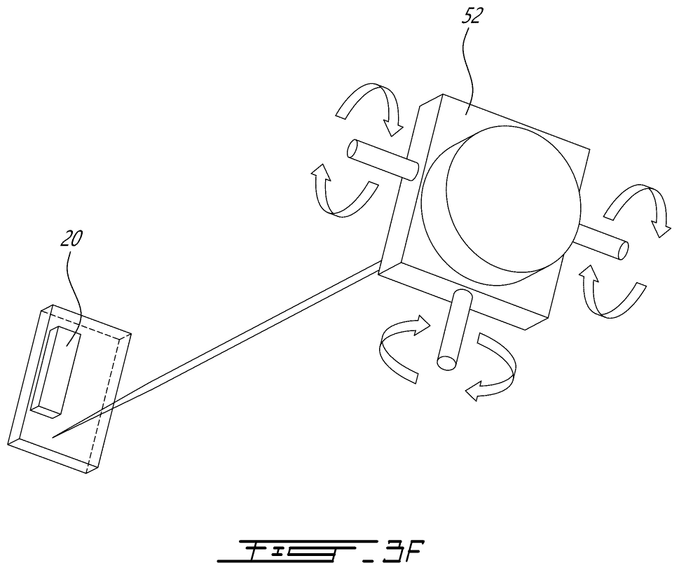

Liquid gallium experiments described hereinbelow in relation to FIG. 3 were conducted using Novacam's Microcam™ 4D interferometer as a light source of the probing pulse used for probing the variation of the surface position over time.

The crater 23 formed by the laser ablation by the ablation pre-pulse 110 from a Ti: sapphire laser L with an output of 210 picoseconds, 50 Hz repetition rate, 793 nm central wavelength and 0.5 to 1 mJ energy, was probed with the Microcam™-4D interferometer 55, with the probing laser pulse 100 of a light wavelength of 1310 nm and a repetition rate of 100 kHz (see FIG. 3B).

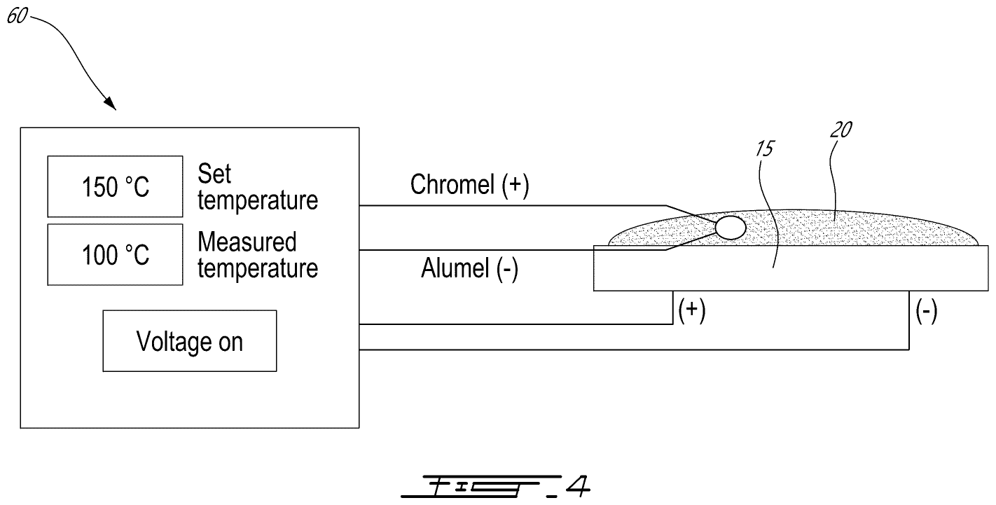

The liquid gallium target 20 is placed on a heating plate 15, for example a positive temperature coefficient (PTC) plate (FIG. 4), under a vacuum in the range between about 10⁻⁵ and about 10⁻⁷ Torr in a vacuum chamber 22, and the ablation pre-pulse 110 is focused onto the liquid gallium target 20 to an intensity between 0.5 10¹⁰ and 1.0 10¹⁰ W/cm² μsing a focusing lens FL 30 (FIG. 3A) (of a focal length of 60 cm. The main pulse 111 has an energy in a range between 1.0 and 4.0 mJ. The focusing lens 102 for the probing pulse 100 has a focal length of 10 cm. Therefore, the liquid gallium target 20 is placed at a distance D of about 10 cm from the focusing lens 102 of the probing pulse 100, and the focal point is adjusted using a moving stage 40 to displace the focusing lens 102 of the probing pulse 100. The galvo scanner 50 of the interferometer 55 is positioned using a translation stage 52 to visualize the surface profile of the liquid gallium after the ablation.

The plasma plume P generated by the pre-pulse 110 on the liquid gallium target 20, and the compressed high intensity femtosecond main pulse 111 drives the high order harmonic generation. Both the pre-pulse and the main pulse are directed to the liquid gallium target 20 using dielectric or metallic mirrors, the pre-pulse making the ablation and the main pulse passing through the plasma plume created by the pre-pulse and hence driving the harmonics, these harmonics being sent through a spectrometer, comprising slit S, grating G, micro channel plate MCP and phosphor screen PS in the embodiment as illustrated in relation to FIG. 3E hereinbelow. The probing pulse is passing through a dichroic mirror DM and then focused on the target so that the probing pulse overlaps with the pre-pulse on the liquid gallium target; the probing pulse provides data regarding the target surface position at different times upon ablation. The silicon mirror SM only directs the harmonics to the XUV spectrometer and blocks the laser.

The focusing lenses are selected to collect the collimated ultrafast laser beam from the laser source and concentrate it to a small focal spot, for intensity enhancements for strong-field Interaction. The translation stage 52 for the galvo scanner 50 of the interferometer 55 is selected so as to move the target 20 in ranges between 1 mm and 25 mm in the X, Y and Z directions inside the vacuum chamber as shown in FIG. 3.

FIG. 3E more precisely shows a Ti: Sapphire laser source L of the picosecond pre-pulse 110 directed by dielectric mirror M to the gallium liquid target material 20 inside the vacuum chamber 22, forming a plasma plume P, and of the compressed high intensity femtosecond main pulse 111 directed by a dielectric mirrors M for the high harmonic generation (HHG), focusing lenses FL taking the collimated ultrafast laser beam from the laser source and concentrating it to a small focal spot on the target material 20; the translation stage 52 connected to the target to move the target in the XYZ directions (best seen in FIG. 3F for example, vacuum chamber not shown in FIG. 3F); the silicon mirror SM placed at the Brewster angle only sending the XUV pulse to the XUV spectrometer, the grating G of the spectrometer dispersing the XUV harmonics received from the slit S based on their wavelength, allowing different harmonic orders to be spatially separated, the micro channel plate MCP disposed so that when the XUV photons strike its surface generate photoelectrons, they trigger a cascade of secondary electrons, amplifying the signal, and the phosphor screen PS coated with a phosphorescent material converting XUV or soft X-ray photons into visible light, so that the XUV radiation may be viewed and analyzed with a standard photo detector D, such as a CMOS camera. The detector D captures images of the spatial distribution of the generated high-order harmonics, including XUV or soft X-ray beams.

The XUV harmonics produced by the HHG process are strongly absorbed by air; the vacuum chamber prevents the harmonic radiation from being absorbed or scattered.

FIG. 4 schematically shows using a proportional integral derivative (PID) thermocontroller 60 to change the temperature of the heating plate 15, and monitoring the temperature of the target liquid gallium 20 using with a chromel/alumel thermocouple.

For controlling the frequency, FIG. 5 shows an input laser chopped by an optical chopper for repetition rate control in experiments: the optical chopper 70 used to frequency shop a pulsed laser 65 input (bottom left handside), the rotation speed of the optical chopper 70 being varied to reach a target frequency (bottom right handside), as measured using a light detector 80, such as a photodiode.

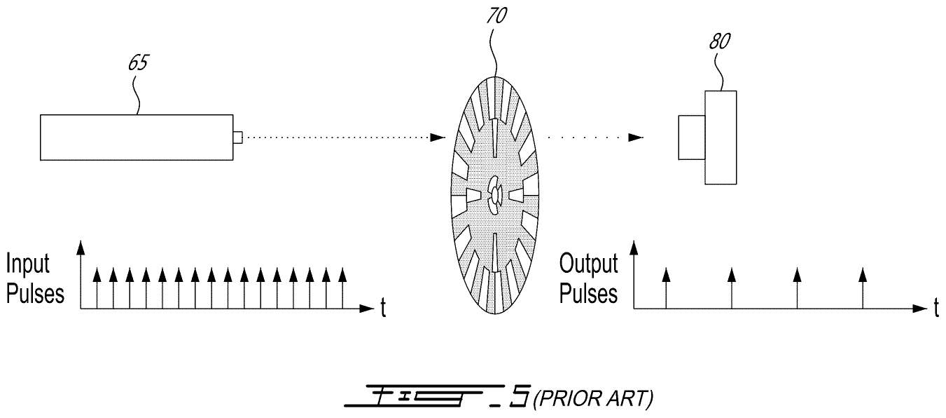

For visualization of the crater, to place the probing pulse 100 on the crater created by the ablation, the entire surface of the liquid gallium target is scanned to determine the coordinates of the crater. In FIG. 6 for example, the probing pulse 100 is placed at the coordinate x=−5.23 mm and y=−2.5 mm of the crater centre.

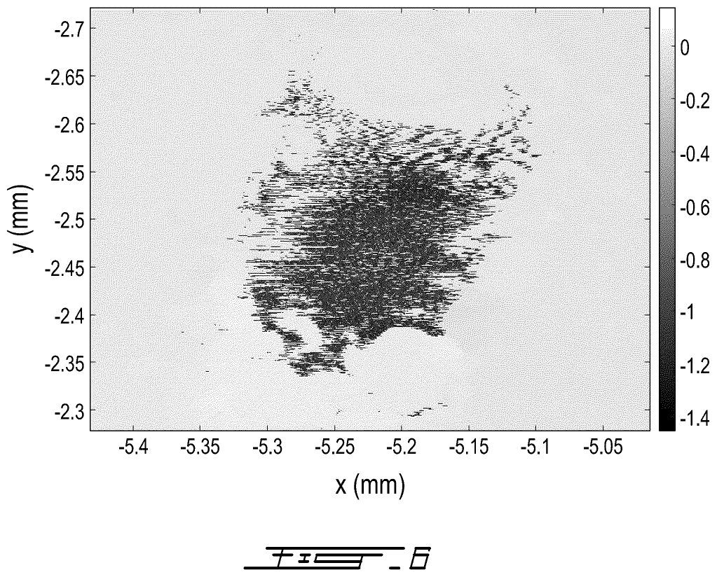

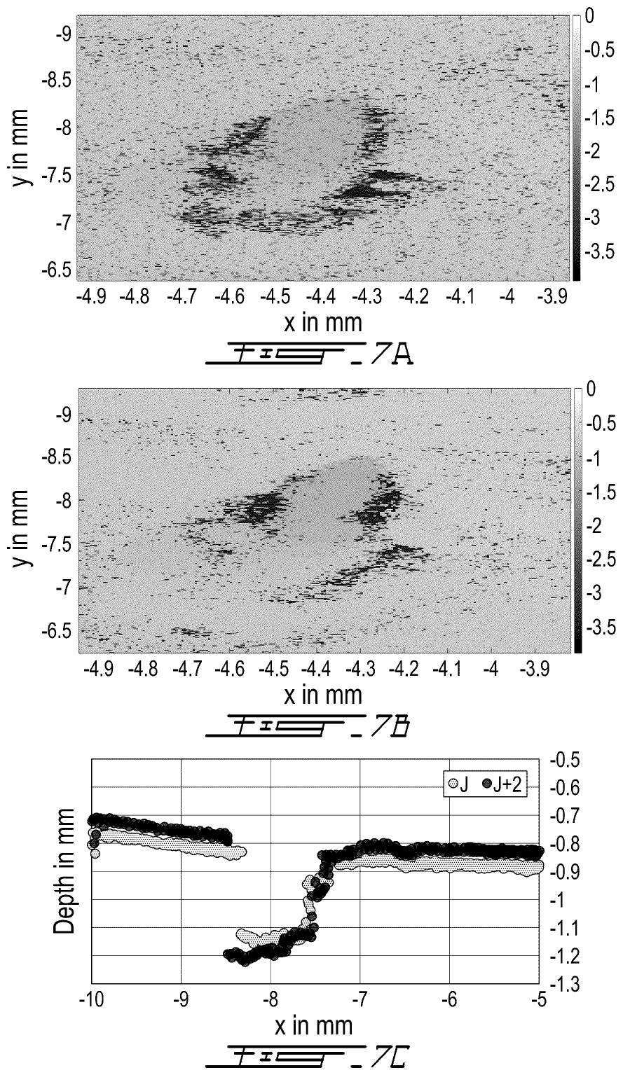

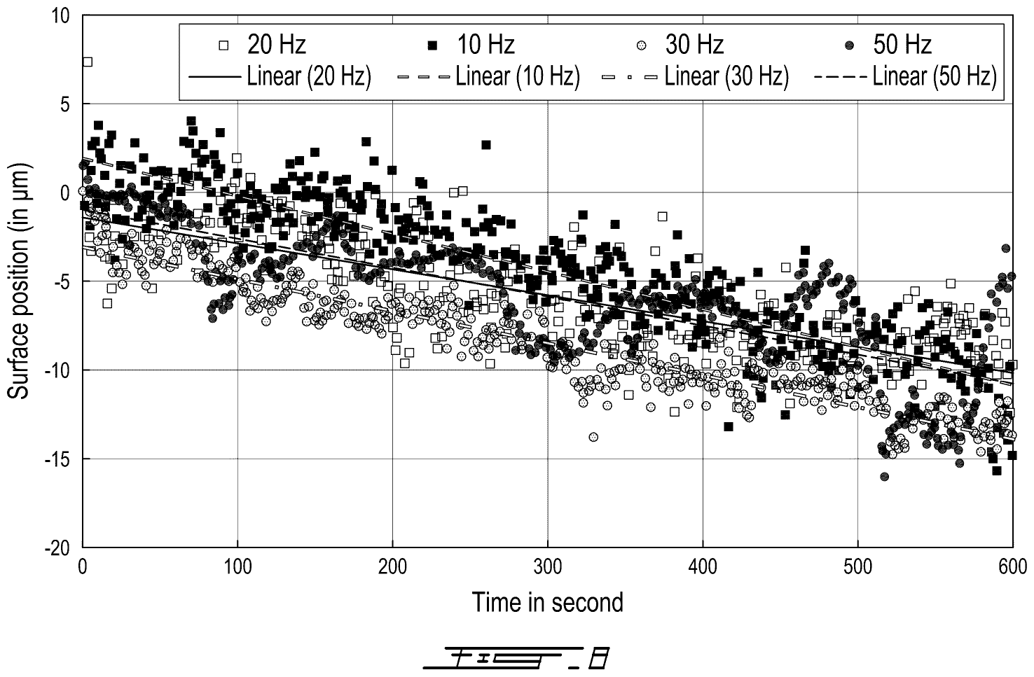

It was expected that the crater on the liquid surface of the target would recover after some delay. However, in the liquid target scanned after 2 days without ablation (J+2), and still the crater with the same depth as day of ablation (J) was observed (FIGS. 7A-7C). In FIG. 7A and FIG. 7B, a high density of pixels observed corresponds to noises that occurred during the scanning around the border of the crater, as a result of reflection of the probing pulse 100 not reaching the interferometer 55. In FIG. 7C, the surface of the liquid target two days after the ablation ((J+2) stippled lines), is seen, with a same depth, upper outside of the crater and lower inside the crater compared to the initial surface of the liquid ((J) straight line). Two days after the ablation experiments, the gallium cooled down and solidified, causing its volume to expand due to its lower density in the solid state compared to the liquid state. This explains why the surface outside the crater rises as a result of solidification. The density of gallium in the solid state is 5.91 g cm³ at about room temperature; the density of gallium in the liquid state is 6.10 g cm⁻³ at the melting point, and becomes smaller than the density of gallium in the solid state at room temperature, at temperatures above 600 K. During ablation, the temperature inside the crater is high enough so that the density of the gallium in the liquid state becomes smaller than that of the gallium in the solid state, resulting in the surface inside the crater deepening when it is solidified.

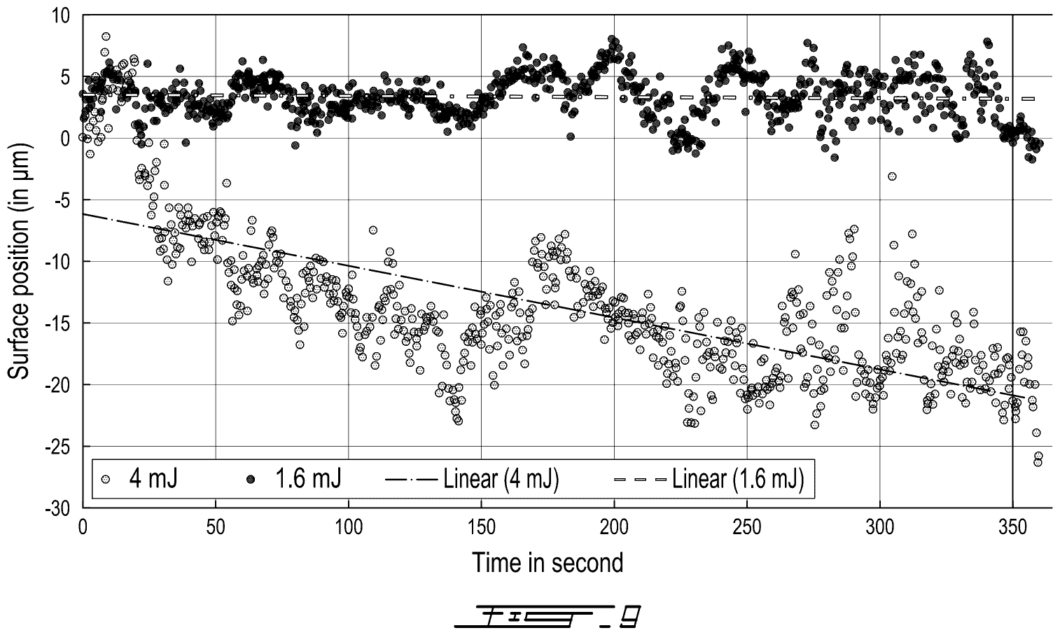

The probing pulse 100 irradiated the crater for 10 minutes and the displacement of the position of the surface of the crater was measured using different repetition rates (10 Hz, 20 Hz, 30 Hz and 50 Hz) of the pre-pulse 110. In FIG. 8, the variation of the position of the surface of the crater shows the same rate of decrease for each repetition rate. However, it was observed that the XUV flux decreases with increased repetition rate, when the observation was done at 50 and 100 Hz.

FIG. 7 shows that the crater does not recover after 2 days without ablation. The liquid is moved to a position lower than its position before ablation, oscillating around this new position, lower than the previous one, as discussed hereinbelow in more detail.

In further experiments, the probing pulse 100 irradiated the crater of the liquid gallium for 6 minutes, and the surface displacement was measured at different ablation energies 1.6 mJ and 4 mJ. As seen in FIG. 9, the position of the surface of the crater decreases faster using an ablation energy of 4 mJ, indicating that the gallium does not have enough time to return to its initial position because the force exerted on the gallium surface by the 4 mJ pre-pulse is stronger.

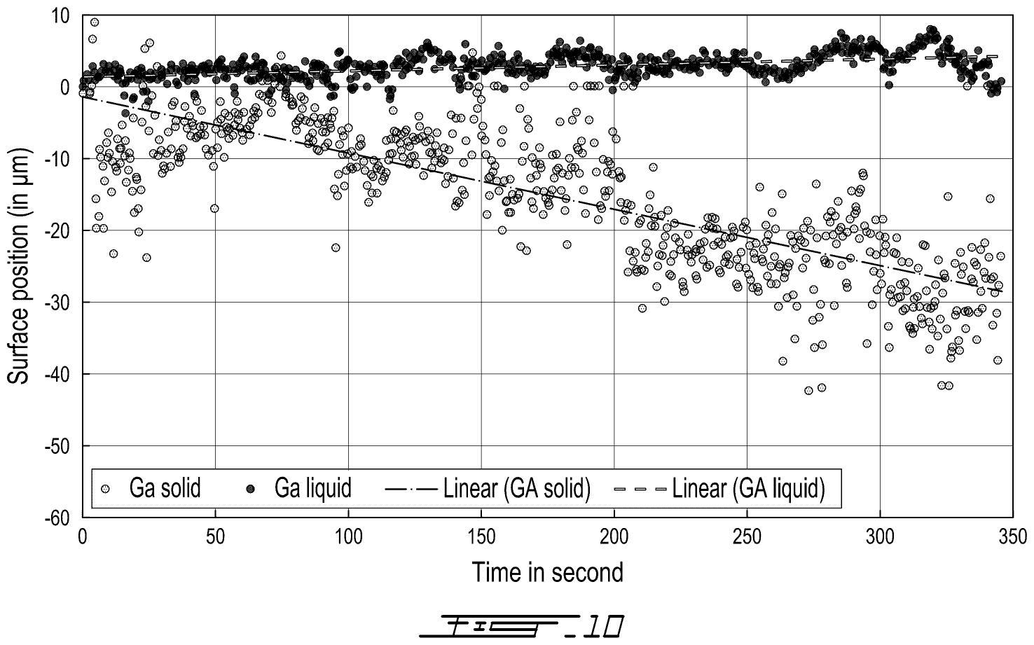

FIG. 10 shows a comparison between gallium targets in the liquid and the solid states. It can be observed that the surface position decreases more rapidly in the solid state than in the liquid state, and that the surface position of the liquid increases over time. This may be explained by the decreasing density of liquid gallium as its temperature increases. However, this behaviour was only observed on some occasions.

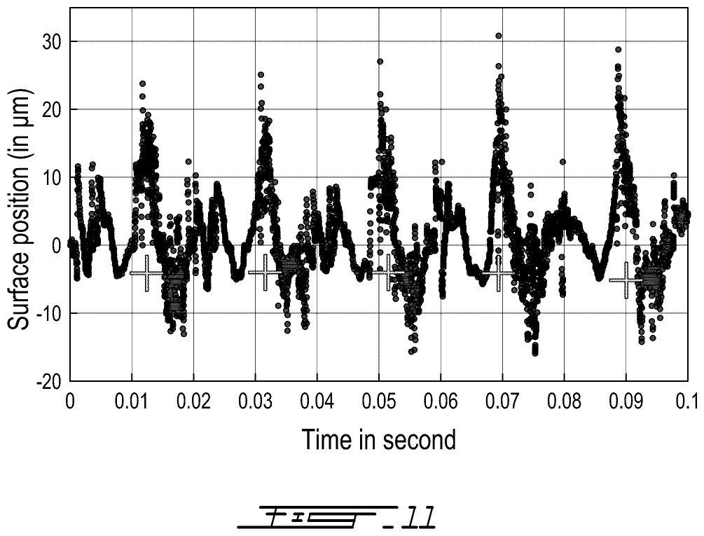

To study the dynamics of the position of the surface of the crater, the surface position was probed each 10 μs because the frequency of the probing pulse is 100 kHz. In FIG. 11, the position of the surface of the gallium is shown after the impact with the pre-pulse (shown by crosses). As splashes can reach between 20 and 30 μm, some waves propagate on the surface of the gallium with an amplitude with the same order of magnitude.

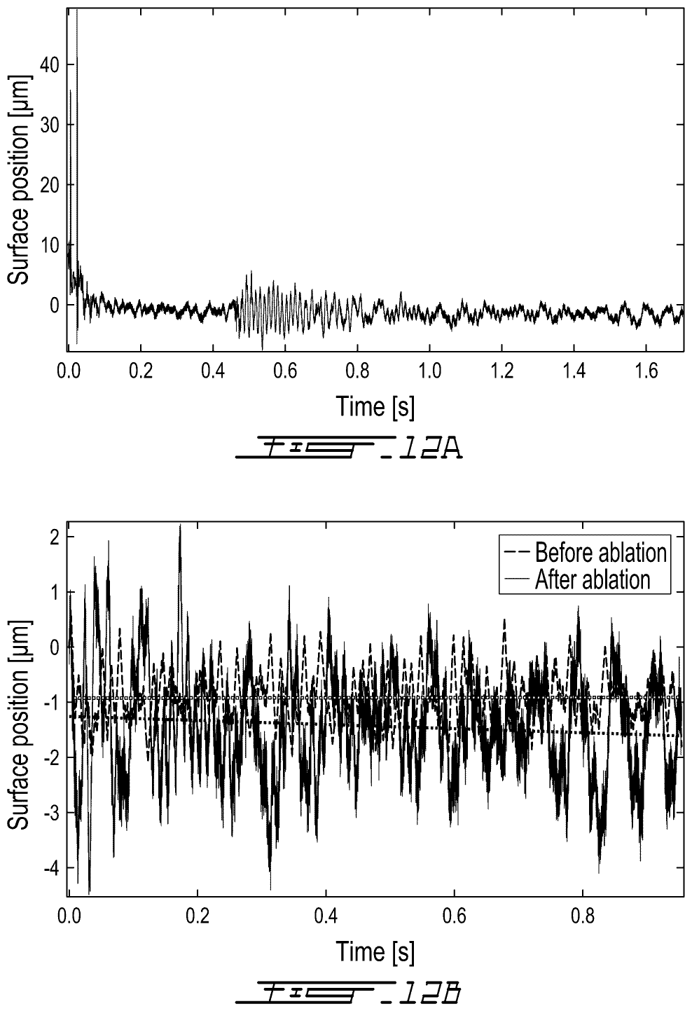

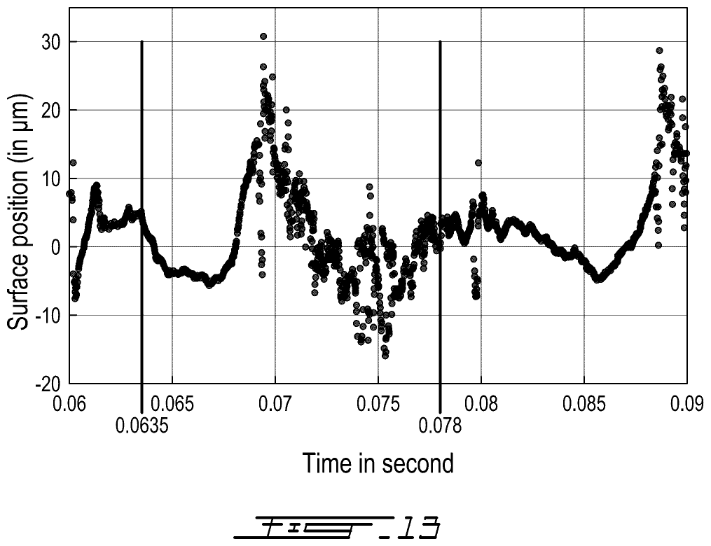

The oscillation of the position of the surface of the crater for one laser shot is shown in FIG. 12A. As seen in FIG. 12B, after the ablation, the position of the surface of the crater oscillates around a new position, which is lower than the initial position before the ablation. The time required for the surface to be at the initial position, as determined on this basis, is about 15 ms (FIG. 13), indicating that the XUV flux decreases faster with a 100 Hz ablation than a 50 Hz ablation. However, a decrease is still seen with 50 Hz because the total height of gallium decreases as its mass reduces.

It is thus shown that increasing the HHG stability by using a metal liquid target allows to use a femtosecond XUV source for more than 800000 shots. In contrast, in the case of liquid X-ray sources, a single shot would blow away the liquid source, and thus, a continuously running source of liquid is necessary. Moreover, whereas plasma emission uses pre-pulse to limit the deposition of debris on the optical system and ablating one drop with one laser shot, it is shown that the liquid target ablated with more than 800000 shots still has the same stability. Using liquid gallium, increased stability for the RH was demonstrated (FIG. 2) and a coherent XUV source with unprecedented stability, intensity and monochromaticity achieved.

There is thus provided a method and a system for generating stable ultrashort pulses of XUV and soft X-ray radiation from laser-ablated plumes of a liquid metal target

There is thus provided a method and a system for generating incoherent XUV sources with high stability. The advantage is that there is no need to synchronize the timing of the metal droplet with the laser pulse, as well as the high stability of the generated XUV source. Such sources may be of significant interest to the semiconductor industry, where XUV lithography is used to fabricate the next generation of microprocessors.

The scope of the claims should not be limited by the embodiments set forth in the examples, but should be given the broadest interpretation consistent with the description as a whole.

1. A system for generating stable ultrashort pulses of XUV and soft X-ray radiation from laser-ablated plumes of a liquid target, comprising:
a laser source a pre-pulse;
a laser source of a main pulse;
wherein the pre-pulse is directed and focused to a surface of the liquid target to ablate the surface of the liquid target, forming a plasma plume generating harmonics; the main pulse being selected for driving the harmonics.

2. The system of claim 1, wherein the pre-pulse is selected with an energy of at least 0.5 mJ; and the main pulse is selected with an energy in a range between 1 and 4 mJ.

3. The system of claim 1, wherein the pre-pulse is selected with an energy in a range between 0.5 and 1 mJ; and the main pulse is selected with an energy in a range between 1 and 4 mJ.

4. The system of claim 1, wherein the pre-pulse is selected with an energy of at least 0.5 mJ; and the main pulse is selected with an energy in a range between 1 and 4 mJ; the system comprising ones of dielectric and metallic mirrors directing the pre-pulse and the main pulse to the surface of the liquid target, the pre-pulse making the ablation and the main pulse passing through the plasma plume created by the pre-pulse and hence driving the harmonics.

5. The system of claim 1, wherein the pre-pulse is selected with an energy in a range between 0.5 and 1 mJ; and the main pulse is selected with an energy in a range between 1 and 4 mJ, the system comprising ones of dielectric and metallic mirrors directing the pre-pulse and the main pulse to the surface of the liquid target, the pre-pulse making the ablation and the main pulse passing through the plasma plume created by the pre-pulse and hence driving the harmonics.

6. The system of claim 1, further comprising a laser source of a probe pulse selected with a higher repetition rate than a repetition rate of the pre-pulse, to probe the surface of the target.

7. The system of claim 1, wherein the pre-pulse is selected with an energy of at least 0.5 mJ; and the main pulse is selected with an energy in a range between 1 and 4 mJ; the system comprising ones of dielectric and metallic mirrors directing the pre-pulse and the main pulse to the surface of the liquid target, the pre-pulse making the ablation and the main pulse passing through the plasma plume created by the pre-pulse and hence driving the harmonics; the system further comprising a laser source of a probe pulse, the probe pulse being directed and focused on the surface of the target to overlap with the pre-pulse on the surface of the liquid target for interferometry to probe the surface of the target.

8. The system of claim 1, wherein the pre-pulse is selected with an energy of at least 0.5 mJ; and the main pulse is selected with an energy in a range between 1 and 4 mJ; the system comprising ones of dielectric and metallic mirrors directing the pre-pulse and the main pulse to the surface of the liquid target, the pre-pulse making the ablation and the main pulse passing through the plasma plume created by the pre-pulse and hence driving the harmonics; the system further comprising a laser source of a probe pulse of a higher repetition rate than a repetition rate of the pre-pulse, the probe pulse being directed and focused on the surface of the target to overlap with the pre-pulse on the surface of the liquid target for interferometry to probe the surface of the target.

9. The system of claim 1, wherein the target is positioned in a vacuum chamber.

10. A method for generating stable ultrashort pulses of XUV and soft X-ray radiation from laser-ablated plumes of a liquid target, comprising:
selecting a pre-pulse and a main pulse; and
directing and focusing the pre-pulse to a surface of the liquid target to ablate the surface of the liquid target, forming a plasma plume generating harmonics; the main pulse being selected for driving the harmonics.

11. The method of claim 10, wherein the pre-pulse is selected with an energy of at least 0.5 mJ; and the main pulse is selected with an energy in a range between 1 and 4 mJ.

12. The method of claim 10, wherein the pre-pulse is selected with an energy in a range between 0.5 and 1 mJ; and the main pulse is selected with an energy in a range between 1 and 4 mJ.

13. The method of claim 10, wherein the pre-pulse is selected with an energy of at least 0.5 mJ; and the main pulse is selected with an energy in a range between 1 and 4 mJ; the system comprising using ones of dielectric and metallic mirrors to direct the pre-pulse and the main pulse to the surface of the liquid target, the pre-pulse making the ablation and the main pulse passing through the plasma plume created by the pre-pulse and hence driving the harmonics.

14. The method of claim 10, wherein the pre-pulse is selected with an energy in a range between 0.5 and 1 mJ; and the main pulse is selected with an energy in a range between 1 and 4 mJ, the method comprising using ones of dielectric and metallic mirrors to direct the pre-pulse and the main pulse to the surface of the liquid target, the pre-pulse making the ablation and the main pulse passing through the plasma plume created by the pre-pulse and hence driving the harmonics.

15. The method of claim 10, further comprising a laser source of a probe pulse selected with a higher repetition rate than a repetition rate of the pre-pulse, to probe the surface of the target.

16. The method of claim 10, wherein the pre-pulse is selected with an energy of at least 0.5 mJ; and the main pulse is selected with an energy in a range between 1 and 4 mJ; the method comprising using ones of dielectric and metallic mirrors to direct the pre-pulse and the main pulse to the surface of the liquid target, the pre-pulse making the ablation and the main pulse passing through the plasma plume created by the pre-pulse and hence driving the harmonics; the method further comprising overlapping a probe pulse with the pre-pulse on the surface of the liquid target for interferometry to probe the surface of the target.

17. The method of claim 10, wherein the pre-pulse is selected with an energy of at least 0.5 mJ; and the main pulse is selected with an energy in a range between 1 and 4 mJ; the method comprising using ones of dielectric and metallic mirrors to direct the pre-pulse and the main pulse to the surface of the liquid target, the pre-pulse making the ablation and the main pulse passing through the plasma plume created by the pre-pulse and hence driving the harmonics; the method further comprising selecting a probe pulse of a higher repetition rate than a repetition rate of the pre-pulse, and directing and focusing the probe pulse to the surface of the target to overlap with the pre-pulse on the surface of the target for interferometry to probe the surface of the target.

18. The method of claim 10, comprising positioning the target under a vacuum in a range between 10⁻⁵ to 10⁻⁷ torr.
